(19) United States
(12) Patent Application Publication
(10) Pub. No.: US 2004/0151491 A1
(43) Pub. Date: Aug. 5, 2004

(54) Apparatus and method concerning a passive multi-indicia visual position indicator

(75) Inventors: Zane Coleman, Chicago, IL (US); Kevin W. Jelley, LaGrange, IL (US); Zili Li, Barrington, IL (US); George Valliath, Buffago Grove, IL (US); Roger Ady, Chicago, IL (US); William Groves, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/357,594

(22) Filed: Feb. 4, 2003

(51) Int. Cl. G03B 13/02

(52) U.S. Cl. 396/376; 396/281; 340/686.1

(57) ABSTRACT

A passive multi-indicia visual position indicator (30) is used to visually indicate to a user (11) when the user occupies a position that comprises a predetermined desired position with respect to a given object (10). The indicator can be comprised of a single integral structure or can be comprised of a plurality portions. The indicator can comprise any of a wide variety of color and/or graphics related imagery. In one embodiment, the indicator has an annularly-shaped form factor. In one embodiment, the indicator comprises an applique that can be provided in a retrofitting kit that includes appropriate corresponding instructions.

### TECHNICAL FIELD

This invention relates generally to objects that serve a particular purpose when a user is located at a predetermined desired position with respect to the object and more particularly to positional confirmation for such a user.

### BACKGROUND

Various objects are known that serve some useful purpose when a user is located at a predetermined desired position with respect to that object. For example, a camera can capture an image of a user when that user is positioned so as to be both properly framed and properly focused by the camera. As another example, a highly directional microphone can capture audio sourced by a user when the user and microphone are properly positioned and oriented with respect to one another.

In some instances, a third party ensures the proper positioning of such a user. A camera operator, for example, can use a camera's viewfinder to guide the user (or the camera) to a proper position and/or to confirm that the user already occupies an appropriate position to facilitate the intended purpose. Such third party intervention or guidance is not always available or convenient, however. For example, a portable two-way wireless communications device may support teleconferencing through use of a small camera lens provided integral to the device housing. By properly holding the device, a user can both speak with a distant party while also transmitting an image of themselves to accompany the audio portion. Under such operational conditions, there typically will be no convenient mechanism by which the user can easily and accurately assure that the video capture device and their own visage are properly positioned with respect to one another.

Some prior art suggestions propose including a movable viewfinder to thereby permit such a user to view their own resultant position with respect to the camera. Such an approach is unfortunately untenable for many applications. In particular, providing a movable viewfinder typically necessitates undesirable form factor and/or power needs requirements that are incompatible with many objects (especially low power portable devices and/or otherwise relatively inexpensive devices). Also, such viewfinders often provide a small image that may not provide sufficient information to the user to accurately ascertain their own position.

### BRIEF DESCRIPTION OF THE DRAWINGS

The above needs are at least partially met through provision of the apparatus and method concerning a passive multi-indicia visual position indicator described in the following detailed description, particularly when studied in conjunction with the drawings, wherein:

FIG. 1 comprises a top plan schematic representation of an object and a properly positioned user as configured in accordance with an embodiment of the invention;

FIG. 2 comprises a perspective schematic representation of an object's zone or corridor of proper user placement as configured in accordance with an embodiment of the invention;

FIG. 3 comprises a top plan schematic representation of an object and variously placed users as configured in accordance with an embodiment of the invention;

FIG. 4 comprises a front elevational view of a passive multi-indicia visual position indicator as disposed on an object as configured in accordance with an embodiment of the invention;

FIG. 5 comprises a front elevational view of a passive multi-indicia visual position indicator comprising a plurality of such indicators as configured in accordance with an embodiment of the invention;

FIG. 6 comprises a front elevational view of a passive multi-indicia visual position indicator as viewed by a properly positioned individual as configured in accordance with an embodiment of the invention;

FIG. 7 comprises a front elevational view of a passive multi-indicia visual position indicator as viewed by an improperly positioned individual as configured in accordance with an embodiment of the invention;

FIG. 8 comprises a top plan schematic detail view of a passive multi-indicia visual position indicator as configured in accordance with an embodiment of the invention;

FIG. 9 comprises a cut-away perspective view of an annularly-shaped a passive multi-indicia visual position indicator as configured in accordance with an embodiment of the invention;

FIG. 10 comprises a front elevational view of a passive multi-indicia visual position indicator as viewed by an improperly positioned user as configured in accordance with an embodiment of the invention;

FIG. 11 comprises a passive multi-indicia visual position indicator as viewed by a properly positioned user as configured in accordance with an embodiment of the invention;

FIG. 12 comprises a top plan schematic detail view of a passive multi-indicia visual position indicator as configured in accordance with an embodiment of the invention;

FIG. 13 comprises a top plan schematic detail view of a passive multi-indicia visual position indicator as configured in accordance with an embodiment of the invention;

FIG. 14 comprises a top plan schematic detail view of a passive multi-indicia visual position indicator as configured in accordance with an embodiment of the invention;

FIG. 15 comprises a top plan schematic depiction of graphic imagery as viewed by a user in different positions as configured in accordance with an embodiment of the invention; and

FIG. 16 comprises a top plan view of a passive multi-indicia visual position indicator kit as configured in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a passive multi-indicia visual position indicator serves to provide information to a user such that the user can then visually ascertain when the user is located at a predetermined desired position with respect to an object. Being passive, the indicator requires no power and therefore will not deplete portable power supplies for objects that operate wholly or partially using such supplies. The indicator can provide such positional information in various forms. Colors and/or specific graphic depictions can aid the user in ascertaining his or her position. Depending upon the environment, such position information can correspond to a desired horizontal position, a desired vertical position, or both. Also if desired, the positional information can reflect depth or distance positioning (either alone or in combination with lateral positioning as noted above).

Depending upon the embodiment, such a passive multi-indicia visual position indicator can comprise a single integral structure or can comprise a plurality of discrete structures that together cooperate to provide the desired information. The indicator can also assume various shapes as appropriate to a given application including an annular shape (the latter being particularly useful when used with circular camera lenses).

Such a passive multi-indicia visual position indicator can be provided with an object by an original manufacturer of the object or can be retrofitted at a later time. To facilitate retrofitting, one embodiment comprises a kit that includes both the passive multi-indicia visual position indicator and corresponding instructions for application and use.

Referring now to the drawings, FIG. 1 generally depicts an object 10 and a user 11. The object can be any object that can serve a particular purpose when the user 11 is located at a predetermined desired position with respect to the object 10 (such as, but not limited to, a still or moving image capture device including both dedicated cameras and two-way wireless communication devices having integral image capture capability, a directional microphone, and so forth). For purposes of these illustrative examples, the object 10 may occasionally be referred to as an image capture device; notwithstanding such references, it should be understood that the invention is not limited in this regard and references to both the object in general and an image capture device in particular shall be understood to refer to all known or hereafter developed platforms with which these teachings can be compatibly employed.

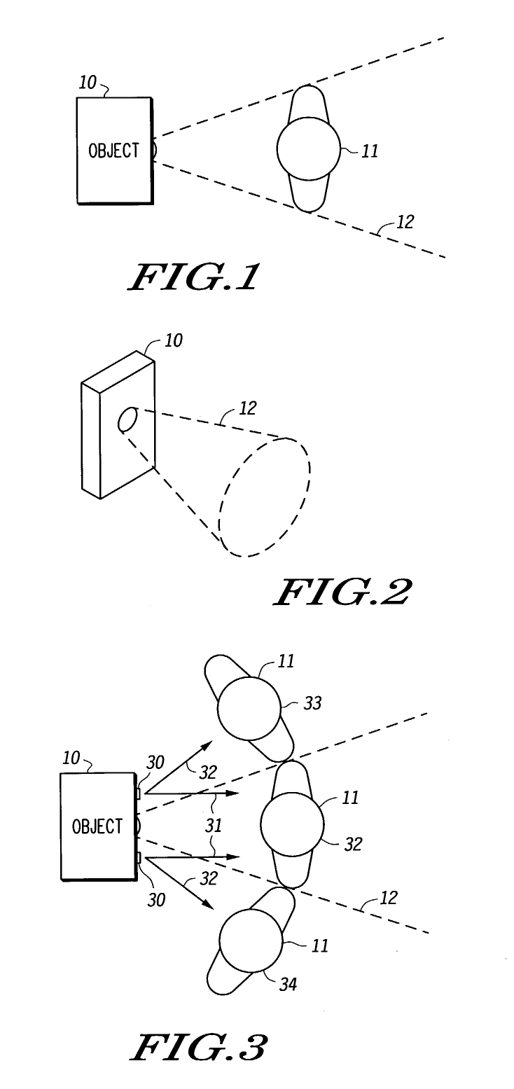

As noted, the object 10 presupposes a predetermined desired orientation with a user 11 to effect its purpose. This predetermined desired position can comprise a horizontal position, a vertical position, or a combination of both (such that the desired position corresponds to a 360 degree range of potential orientation). In some applications, distance between the object 10 and the user 11 can also serve to define the predetermined position. In the example presented, the predetermined position comprises a plurality of acceptable positions within a range of positions that are defined by a corridor 12 of such positions. In this illustration, when the object 10 comprises an image capture device, the corridor 12 would correspond to the framing of the device. As perhaps better depicted in FIG. 2, the corridor 12 is circumscribed by both horizontal and vertical limits (and possibly depth or distance limits) that correspond to the framing (and possibly the focusing) limits of the object 10.

So configured, the object 10 will serve to properly capture an image of the user 11 provided the user 11 occupies a location that corresponds with the predetermined desired position. Conversely, the object 10 will not be able to capture an image of the user 11 when the user 11 occupies a location that is distal to the predetermined desired position (when, for example, the user 11 is outside the corridor 12 that defines, in this example the image capture frame view of the object 10).

Pursuant to these various embodiments, a passive multi-indicia visual position indicator 30 on the object 10 provides positional information to the user 11 to permit the user 11 to thereby visually ascertain when the user 11 is located at the predetermined desired position with respect to the object. In particular, the user 11 will see a first visual image or indicia 31 when located 32 at the predetermined desired position and other, different visual image or indicia 32 when located 33 and 34 at other than the predetermined desired position (i.e, in this example, when located outside the corridor 12). These differing visual indicia 31 and 32 serve to thereby advise the user 11 of these relative positions.

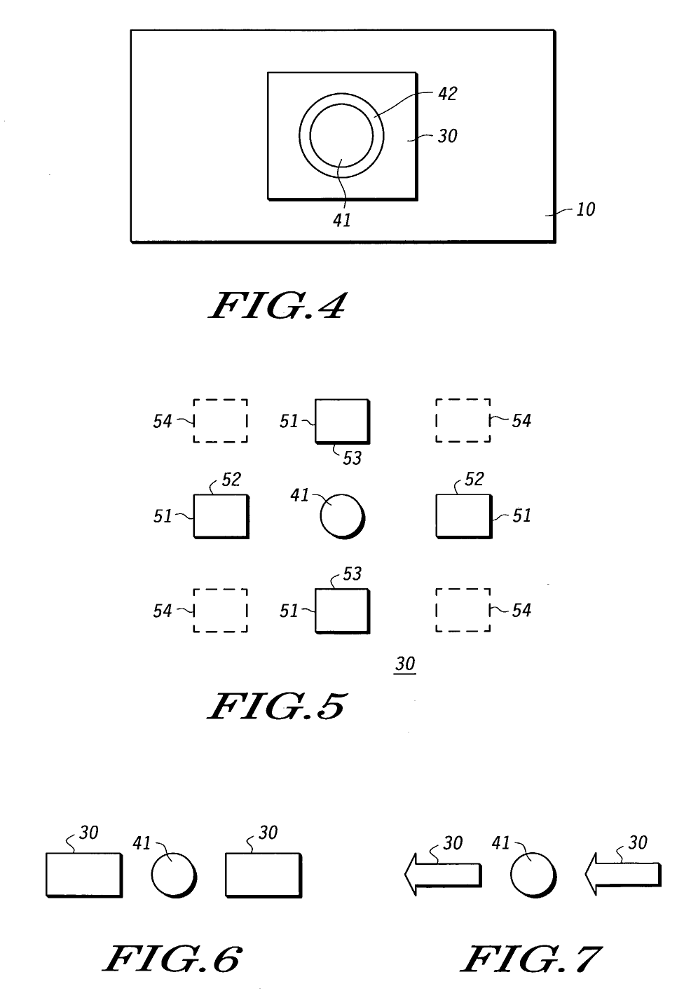

The passive multi-indicia visual position indicator 30 can be realized in a variety of ways. For example, and as will be described below in more detail, the passive multi-indicia visual position indicator 30 can be comprised of one or more lenticular prints, parallax prints, or louver films (and/or any combination thereof), to name a few. Further, the passive multi-indicia visual position indicator 30 can assume any number of shapes or sizes to suit a given application. As one example, and referring now to FIG. 4, the passive multi-indicia visual position indicator 30 can comprise a rectangular shaped indicator having a circular opening 42 to accommodate the circular shaped lens 41 of the object 10. So configured, the relative position-dependent color and/or graphic visual imagery of the passive multi-indicia visual position indicator 30 substantially surrounds that part of the object 10 that tends to be most sensitive to the user's position.

Other form factors are possible and, indeed, possibly preferable for certain applications. For example, and referring now to FIG. 5, the passive multi-indicia visual position indicator 30 can be comprised of a plurality of indicator portions 51. In one embodiment, four such portions 51 are substantially equally disposed around, for example, an image capture lens 41 of an object. So configured, if desired, two of the portions 52 can be configured to provide visual cues regarding horizontal positioning of the user and two of the portions 53 can be used to provide visual cues regarding vertical positioning of the user. If desired, fewer portions 51 could be used as well. Or, if desired, additional portions 54 could be used in conjunction with the previously described portions 51. In this particular illustration, such additional portions 54 are disposed in opposing corners around the lens 41. So positioned, yet additional horizontal/vertical positioning indicia can be readily provided to a user.

As noted earlier, the passive multi-indicia visual position indicators 30 can provide graphic imagery that uniquely corresponds to positional orientation if so desired. For example, and referring now to FIG. 6, the passive multi-indicia visual position indicator 30 can comprise two indicator portions that are disposed on either side of an image capture lens 41. Both portions of the indicator 30 can visually appear as rectangles to a properly positioned user (also, if desired, these rectangles can comprise a corresponding color, such as, for example, green). These same indicator portions, however, can appear as, for example, arrowheads to an improperly positioned user as illustrated in FIG. 7 (also, if desired, these arrowheads can comprise a corresponding color, such as, for example, red). So configured, the user can perceive an indicator 30 that assumes a different shape (and/or size) depending upon the user's position relative to the object. Furthermore, the visual indicia itself can suggest a particular direction in which the user should move in order to more likely assume the desired position (for example, the arrowheads depicted in FIG. 7 can be styled to point in the direction that the user should move to become properly positioned).

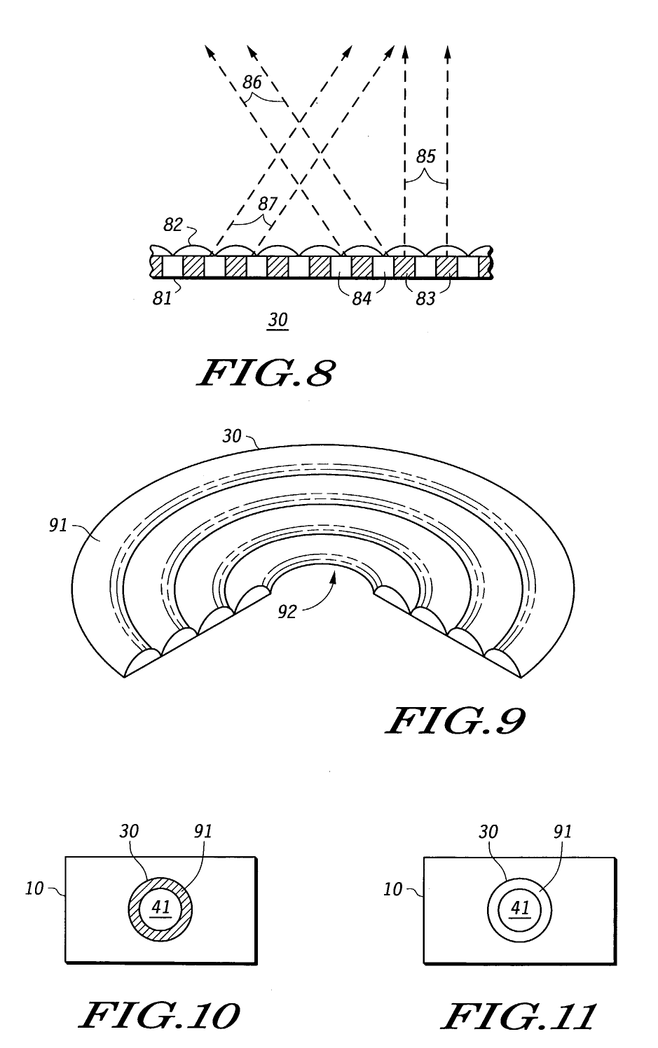

As noted above, the passive multi-indicia visual position indicator 30 can be comprised, in one embodiment, of a lenticular print. Lenticular prints are well known and understood in the art and hence need not be described here in great detail. It should be noted, however, (and referring now to FIG. 8) that a typical lenticular print includes a substrate 81 having a desired pattern printed thereon and a set of cylindrical lenses 82 disposed thereover. So configured, the lenses 82 direct portions of the imagery of the printed pattern in various predictable directions. As a simple example, the printed pattern 81 can comprise alternating sections of green color 83 and red color 84. By disposing the green color 83 portions under a portion of the lenses 82 that tends to direct the resultant green image 85 outwardly at a substantially normal angle, the green color will be readily perceived by a user positioned in this normal path of travel. Similarly, by placing the red color portions 84 beneath portions of the lenses 82 that tend to direct the result red imagery to either the left 86 or the right 87 will likewise tend to present a resultant red image to a user who also occupies a position to the left or right of center.

So configured, the lenticular print will present a first color (green) to a correctly positioned user and a second color (red) to an incorrectly positioned user. The user can then simply adjust either themselves or the object until they can see the first color as versus the second color.

This approach offers numerous advantages. Lenticular prints are relatively inexpensive and easy to form and apply. They require no operational power from the object and can be configured to facilitate a relatively intuitive instructional motif for even an untrained user. Such prints also readily support the use of two (or more) different colors and/or graphic images to uniquely identify positional zones of interest or concern. For example, three (or more) visual indicia can be provided in this way to indicate proper positioning, close but incorrect positioning, and distant, incorrect positioning of the user.

In general, lenticular prints tend to use horizontally (or vertically) parallel lenses. If desired, however, the lenses can be configured as annularly concentric lenses 91 as illustrated in FIG. 9. So configured, a space 92 can be centrally formed to facilitate placement of the annularly concentric indicator 30 around, for example, an image capture lens 41 as depicted in FIGS. 10 and 11. So configured, the form factor of the indicator 30 closely matches that of the image capture lens 41. When green and red colors are used as suggested above, a properly positioned user will tend to see a green colored ring around the lens 41 (as suggested in FIG. 10) and an improperly positioned user will tend to see a red colored ring around the lens 41 (as suggested in FIG. 11). It should be noted that such concentric lenticular lenses 91 would generally tend to respond to a full 360 degrees of user positioning possibilities and thereby correspond well to a valid corridor of accepted positions as illustrated earlier.

The passive multi-indicia visual position indicator 30 can also be realized through use of parallax printing techniques. With reference to FIG. 12, parallax prints typically comprise a transparent substrate 121 with opaque printing on an exterior surface 122 and a printed pattern on an inward surface 123 thereof (with “exterior” referring to a user side of the substrate 121 and “inward” referring to an opposite side of the substrate 121). So configured, pattern images on the inward surface are only viewable to the extent that a user's viewing angle aligns with the pattern with respect to the occluding pattern on the outward surface. For example, if green colored areas 124 are aligned with the light-passing apertures 125 on the exterior surface 122, a user who is positioned normal to the structure will tend to see green 126. Similarly, a user positioned to the side will tend to see whatever other color or pattern is formed on the inward surface. For example, when the green colored areas 124 alternate with red colored areas 127 the improperly positioned user will tend to see red 128. As with the lenticular print, such a parallax print can be readily used to provide a passive multi-indicia visual position indicator as otherwise set forth above.

Parallax mirror printing can also be used in a similar fashion. With reference to FIG. 13, such a structure typically comprises a transparent substrate 131 having a mirrored surface 132 and an exterior surface that again features a printed pattern to permit reflected light to exit there through. In this embodiment, however, it is a color in that printed pattern that is reflected by the mirrored surface 132 to provide the indicia of improper positioning. For example, a red color in that printed pattern will be reflected by the mirrored surface 132. The resultant reflected escaping red light 133 departs at an angle and hence is visible to a user standing other than at the desired position. Proper positioning, on the other hand, is indicated by ambient light 134 that is reflected back outwards towards a properly positioned user. One potential benefit of using parallax mirror prints is that the substrate 131 may potentially be thinner than might otherwise be required for similar results with standard parallax printing techniques.

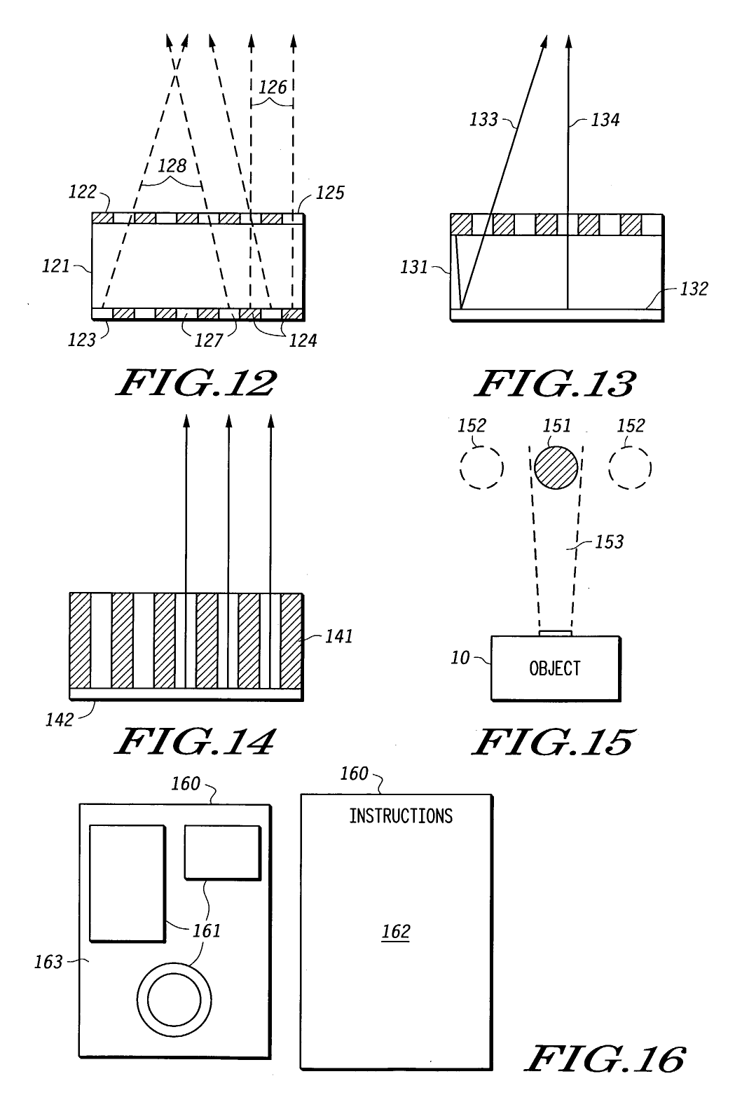

Yet another approach, the use of louver film with corresponding images, can be used to provide a usable passive multi-indicia visual position indicator under at least some operating conditions. With reference to FIG. 14, louver film (such as 3M's Light Control Film) 141 provides an apertured substrate that only permits an underlying color and/or image 142 to be viewed from within a relatively narrow viewing angle. With reference to FIG. 15, the underlying color and/or image 151 can be viewed by a user when the user is located at a predetermined desired position 153. The color/image is not viewable 152, however, by a user located distal to the predetermined desired position.

It should be appreciated that there are various ways to effect provision of a passive multi-indicia visual position indicator, including both the various approaches and embodiments as set forth above as well as other methodologies that may be now known or later developed.

As noted earlier, the passive multi-indicia visual position indicator can be included with an object as originally manufactured or added later by a dealer, service shop, user, or the like. To facilitate such retrofitting, the passive multi-indicia visual position indicator can be provided as a kit. As illustrated in FIG. 16, such a kit 160 can include at least one passive multi-indicia visual position indicator applique 161 and a corresponding set of placement instructions 162. The passive multi-indicia visual position indicator applique 161 can comprise one of many such appliques as presented on one or more sheets 163. In one embodiment, each applique 161 can be particularly suited to a specific corresponding object. For example, one applique can be specifically appropriate for use with a first camera-capable cellular telephone while another applique can be specifically appropriate for use with a different camera-capable cellular telephone. In a preferred embodiment, the appliques 161 would have an adhesive backing that readily separates from the backing sheet 163 while simultaneously adhering securely to an object of choice. The instructions can include information to aid the installer in selecting a particular applique (especially when multiple candidate appliques are available in the kit 160) for a given object. The instructions can include corresponding text (in one or more languages of choice) and/or graphic images as appropriate to a given target audience. The instructions can also include information regarding use of the passive multi-indicia visual position indicators subsequent to installation of such indicators. In one embodiment, the appliques and instructions could be packaged together in a plastic bag. Pursuant to another approach, the instructions could be presented on card stock with the appliques being combined-therewith in a so-called blister pack. Other packaging options as well understood in the art are also available and may be used as desired.

The passive multi-indicia visual position indicator as described above consumes no object power and provides a relatively simple and inexpensive mechanism to provide a relatively intuitive visual indicator to a person regarding their position with respect to a given object. A virtually limitless variety of form factors can be readily accommodated as can a wide variety of visual indicia. Furthermore, the indicator is well suited to both initial installation by a manufacturer and to latter retrofitting as well.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. An apparatus comprising:
an object that serves at least one purpose when a user is located at a predetermined desired position with respect to the object;
a passive multi-indicia visual position indicator disposed on the object;
such that when the user views the passive multi-indicia visual position indicator, the user can thereby visually ascertain when the user is located at the predetermined desired position with respect to the object.

2. The apparatus of claim 1 wherein the object comprises a wireless communication device and the at least one purpose comprises image capture.

3. The apparatus of claim 1 wherein the passive multi-indicia visual position indicator comprises at least one of a lenticular print, a parallax print, and a louver film.

4. The apparatus of claim 1 wherein the passive multi-indicia visual position indicator provides a first visual image to a user located at the predetermined desired position and a second visual image, which second visual image is different from the first visual image, to a user located outside the predetermined desired position.

5. The apparatus of claim 4 wherein the first visual image includes at least a first color that is different from a color that comprises the second visual image.

6. The apparatus of claim 4 wherein the first visual image includes at least one graphic image that is unique as compared to the second visual image.

7. The apparatus of claim 1 wherein the passive multi-indicia visual position indicator comprises a substantially annular-shaped passive multi-indicia visual position indicator.

8. The apparatus of claim 1 wherein the user can thereby visually ascertain when the user is located at a predetermined desired horizontal position with respect to the object.

9. The apparatus of claim 1 wherein the user can thereby visually ascertain when the user is located at a predetermined desired vertical position with respect to the object.

10. The apparatus of claim 1 wherein the user can thereby visually ascertain when the user is located at a predetermined desired horizontal and vertical position with respect to the object.

11. The apparatus of claim 1 wherein the user can thereby visually ascertain when the user is located at a predetermined desired distance from the object.

12. The apparatus of claim 1 wherein the predetermined desired position comprises a position within an image capture frame view of the object.

13. A kit comprising:
at least one passive multi-indicia visual position indicator applique;
instructions regarding placement of the at least one passive multi-indicia visual position indicator applique on an object, which object serves at least one purpose when a user is located at a predetermined desired position with respect to the object, such that when the user views the passive multi-indicia visual position indicator applique, the user can thereby visually ascertain when the user is located at the predetermined desired position with respect to the object.

14. The kit of claim 13 wherein the instructions regard placement of the at least one passive multi-indicia visual position indicator applique on an object comprising a wireless communication device that includes an image capture capability.

15. The kit of claim 13 wherein the passive multi-indicia visual position indicator applique comprises at least one of a lenticular print, a parallax print, and a louver film.

16. The kit of claim 13 wherein the passive multi-indicia visual position indicator applique, when placed in accordance with the instructions, provides a first visual image to a user located at the predetermined desired position and a second visual image, which second visual image is different from the first visual image, to a user located outside the predetermined desired position.

17. The kit of claim 16 wherein the first visual image includes at least a first color that is different from a color that comprises the second visual image.

18. The kit of claim 16 wherein the first visual image includes at least one graphic image that is unique as compared to the second visual image.

19. The kit of claim 13 wherein the passive multi-indicia visual position indicator applique comprises a substantially annular-shaped passive multi-indicia visual position indicator applique.

20. The kit of claim 19 wherein the instructions at least suggest placement of the substantially annular-shaped passive multi-indicia visual position indicator applique around an image capture device.

21. A method for use with an object that serves at least one purpose when a user is located at a predetermined desired position with respect to the object, comprising:
providing at least one passive multi-indicia visual position indicator;
disposing the at least one passive multi-indicia visual position indicator on the object, such that when the user views the passive multi-indicia visual position indicator, the user can thereby visually ascertain when the user is located at the predetermined desired position with respect to the object.

22. The method of claim 21 wherein providing at least one passive multi-indicia visual position indicator includes providing at least one of a lenticular print, a parallax print, and a louver film.

23. The method of claim 21 wherein disposing the at least one passive multi-indicia visual position indicator on the object includes disposing the at least one passive multi-indicia visual position indicator on the object, wherein the passive multi-indicia visual position indicator provides a first visual image to a user located at the predetermined desired position and a second visual image, which second visual image is different from the first visual image, to a user located outside the predetermined desired position, such that the user can thereby visually ascertain when the user is located at the predetermined desired position with respect to the object.

24. The method of claim 21 wherein disposing the at least one passive multi-indicia visual position indicator on the object includes disposing an annular shaped passive multi-indicia visual position indicator on the object.

25. The method of claim 21 wherein disposing the at least one passive multi-indicia visual position indicator on the object includes disposing a plurality of passive multi-indicia visual position indicators on the object.

26. The method of claim 21 wherein providing at least one passive multi-indicia visual position indicator includes providing at least one passive multi-indicia visual position indicators that provides at least three visual indicia that correspond to different positions of the user with respect to the object.
